(19) United States
(12) Patent Application Publication
(10) Pub. No.: US 2024/0227157 A1
(43) Pub. Date: Jul. 11, 2024

(54) TOOL BAG ORGANIZATION SYSTEM AND METHODS OF ORGANIZING TOOLS

(71) Applicant: David Usher Jr, Anchorage, AK (US)

(72) Inventor: David Usher Jr, Anchorage, AK (US)

(21) Appl. No.: 18/151,110

(22) Filed: Jan. 6, 2023

(51) Int. Cl. B25H 3/02; B65B 5/06; B65D 25/10

(52) U.S. Cl. CPC B25H 3/021; B65B 5/067; B65D 25/108

(57) ABSTRACT

A method of organizing tools in a tool bag includes inserting a tool organizer insert into a tool bag opening, wherein the tool organizer insert includes a top substantially flat elongated section including one or more tool holes for the holding and organization of tools, and two sides disposed substantially at 90° angles to the flat elongated section, and when the tool organizer insert is inserted into the tool bag, the top substantially flat elongated section is disposed near a top of the tool bag opening and the two sides disposed at substantially 90° angles project downward into the tool bag.

### BACKGROUND

### Description of the Related Art

Tool bags are typically bags made of a soft or flexible material containing a large pocket or opening for the holding and carrying of tools. Tool bags, however, have only limited means for organizing the tools within the tool bag. For example, there may be some pockets or holders but these are insufficient to hold and organize a large number of tools. The majority of tools can then only be simply put into the pocket in a disorganized fashion leaving it difficult to find a particular tool when needed. Furthermore, the storing of tools in this fashion usually requires purchasing several tool bags for storing different sets of tools.

### SUMMARY OF THE INVENTION

A method of organizing tools in a tool bag includes inserting a tool organizer insert into a tool bag opening, wherein the tool organizer insert includes a top substantially flat elongated section including one or more tool holes for the holding and organization of tools, and two sides disposed substantially at 90° angles to the flat elongated section, and when the tool organizer insert is inserted into the tool bag, the top substantially flat elongated section is disposed near a top of the tool bag opening and the two sides disposed at substantially 90° angles project downward into the tool bag.

Other features and aspects will be apparent from the following detailed description, the drawings, and the claims.

### BRIEF DESCRIPTION OF THE DRAWINGS

FIG. 1 shows an exemplary tool bag 100 of the invention.

FIG. 2 shows a tool bag 100 showing a central opening.

FIG. 3 shows a tool organizer insert of the invention.

FIG. 4 shows another view of a tool organizer insert of the invention.

FIG. 5 shows another exemplary tool bag of the disclosure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DISCLOSURE OF THE INVENTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

The invention provides a tool storage system including a tool bag and a tool insert organizer slidably insertable into a tool bag. The invention thus provides methods of organizing tools in a tool bag using a tool insert organizer.

A tool bag of a tool storage system of the disclosure is typically made of a durable or heavy canvas, leather, or synthetic material. Synthetic materials typically include polyester. A typical tool bag includes an opening with, optionally, pockets located along the one or several of the walls of the opening. In some tool bags, the opening may be divided into two or more compartments. Some tool bags have a frame around the opening permitting the bag to stay open when in use. Many tool bags have pockets on the outside as well as the inside. The bag will usually include handles and a shoulder strap. Tool bags may have a zipper or leather strap closure for the opening or pocket. The opening or pocket may be divided into compartments as well.

In one specific embodiment, the tool bag may be carried on a belt that wraps around the user's waist. In an embodiment, there may be two such bags on the belt that can be positioned, for example, on either side of the wearer. The tool bag may have pockets on the inside and/or the outside of the bag.

Tool bags can typically range in size from about 12 inches to 20 inches long, 4 to 12 inches wide and 6 to 18 inches high. Typical standard sizes for a tool bag include 14, 16, and 18 inches long, 8 to 10 inches wide, and 10 to 12 inches high.

More specifically, the dimensions for the large opening pouch can be about 9″ long and 4″ wide with a 3″ leg. For smaller pouches the tool organizer insert can be sized down. In one embodiment, the tool bag insert can fill approximately half the space of the opening and allow for tool tips to be in the smaller holes and still have access to screws in the bottom of the pouch. As such, in this embodiment, the tools will be positioned more or less vertically in the bag while being held in the insert.

In the disclosed tool storage system and methods of organizing tools, a tool organizer insert is provided and is inserted into the central opening of the tool bag. The tool organizer insert is generally made of a rigid plastic or thin standard gauge metal. For example, the thickness of the metal may be anywhere from 1 to 38 gauge including each integer gauge in between (i.e., 1, 2, 3, 4, 5, . . . 38). This would correspond to about 0.16 mm to about 7.15 mm thick with each intervening standard gauge thickness included. See e.g., sheet metal, Wikipedia, the free encyclopedia, last edited 1 Jan. 2023, herein incorporated by reference. Generally, the material can also be plastic, rubber, or any light metal.

A tool organizer insert generally includes three substantially flat elongated sides arranged generally at 90° angles to each other. The three sides resemble an open rectangular or cuboid box shape with several of the sides open. Thus, the tool organizer insert may comprise one top flat elongated section with two sides projecting downwards of roughly equal length and width. The top flat elongated section includes tool holes of various shapes and sizes. The geometry of the tool holes may be circular, oval, rectangular, square, triangular, cuboid, or any other appropriate geometrical shape for holding tools. The tool holes are used to hold and organize tools which are inserted into the holes for organization and storage. In embodiments, the tools are inserted vertically into the holes and held essentially vertically in the insert. In embodiments, the three sides of the tool organizer insert may be integrally formed. The tool holes may range from about ⅛″ wide (or in diameter) to up to about 10 inches wide or long.

A method of organizing tools in a tool bag includes inserting a tool organizer of the invention into the central opening of a tool bag. The tool organizer insert is inserted with the top elongated section including tool holes positioned at the top of the tool bag opening and the two sides, at roughly 90° angles to the top elongated section, projecting downward into the tool bag. The tool organizer insert will then form an open space below the top flat elongated section and between the two sides of the tool bag.

The method of organizing tools also includes inserting a tool organizer insert of the invention into one or more compartments of a tool bag that includes an opening divided into two or more compartments. The process also includes steps of storing and organizing tools in the tool organizer insert in the tool bag. The process further includes organizing a plurality of tools

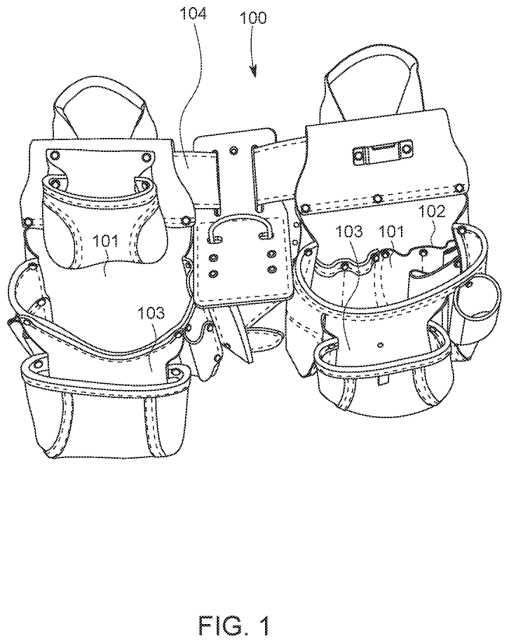

FIG. 1 shows a tool bag 100 of the disclosure with openings 101, inside pockets 102, outside pockets 103, and belt 104.

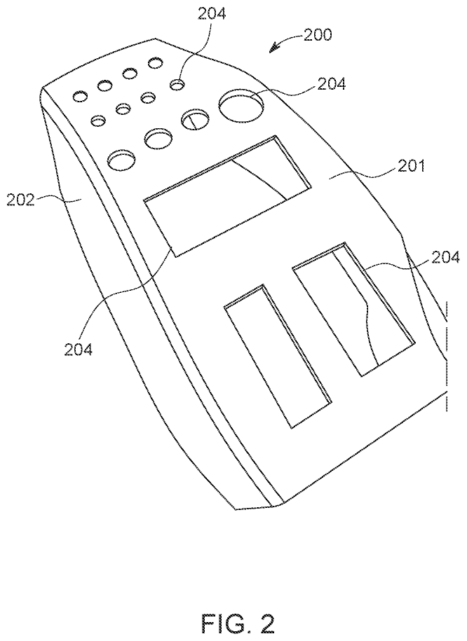

FIG. 2 shows a tool organizer insert 200 with top elongated section 201 and side 202 at an approximately 90° angle and tool holes 204.

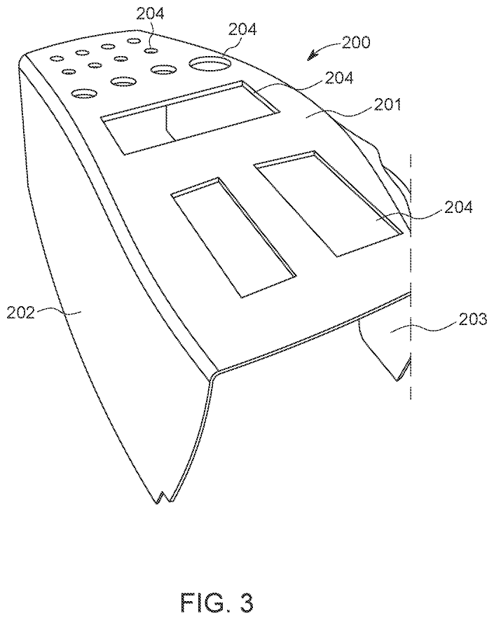

FIG. 3 shows another view of a tool organizer insert 200 with top elongated section 201, sides 202 and 203, and tool hole openings 204. The smallest circular tool hole openings 204 in this example may be about 3/16″ wide and the largest circular holes about 3 inches wide. The rectangular tool holes may range from about 2-4 inches wide and 2-8 inches long.

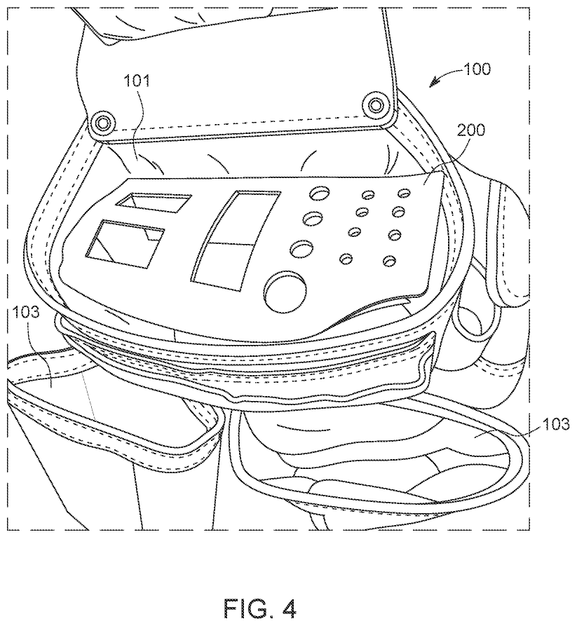

FIG. 4 shows a tool bag of the disclosure 100 with tool organizer insert 200 inserted into opening 101.

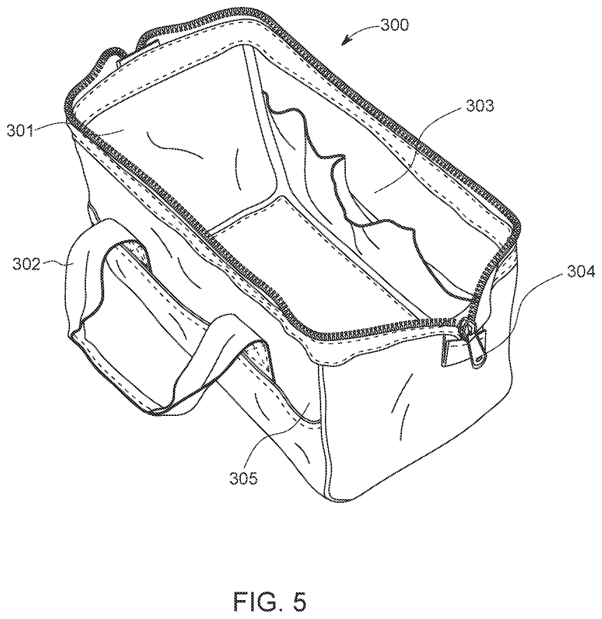

FIG. 5 shows another exemplary tool bag 300 of the disclosure. FIG. 5 shows opening 301, handle 302, zipper 304, inside pockets 303, and outside pockets 305.

While this disclosure includes specific examples, it will be apparent after an understanding of the disclosure of this application has been attained that various changes in form and details may be made in these examples without departing from the spirit and scope of the claims and their equivalents.

1. A method of organizing tools in a tool bag comprising an opening, comprising:
inserting a tool organizer insert into the tool bag, wherein the tool organizer insert comprises a top substantially flat elongated section comprising one or more tool holes for holding and organizing tools, and two sides disposed at substantially 90° angles to the flat elongated section and when the tool organizer insert is inserted into the tool bag, the top substantially flat elongated section is disposed near a top of the tool bag and the two sides are disposed at substantially 90° angles to the flat elongated section and project downward into the tool bag; and
inserting one or more tools into the one or more tool holes.

2. The method of organizing tools of claim 1, wherein the tool organizer insert comprises a hard plastic.

3. The method of organizing tools of claim 1, wherein the tool organizer insert comprises sheet-metal.

4. The method of organizing tools of claim 1, where and the one or more tool holes comprise circular, square, or rectangular shaped holes.

5. The method of organizing tools of claim 1, wherein the tool bag comprises two or more compartments and the tool organizer insert is inserted into one of the compartments.

6. The method of organizing tools of claim 1, wherein the tool organizer insert fills the entirety of the tool bag opening.
